(19) United States
(12) Patent Application Publication
(10) Pub. No.: US 2025/0240150 A1
(43) Pub. Date: Jul. 24, 2025

(54) METHOD AND APPARATUS FOR GENERATING SEARCHABLE ENCRYPTED DATA

(71) Applicant: ELECTRONICS AND TELECOMMUNICATIONS RESEARCH INSTITUTE, Daejeon (KR)

(72) Inventor: Ju-Young KIM, Daejeon (KR)

(73) Assignee: ELECTRONICS AND TELECOMMUNICATIONS RESEARCH INSTITUTE, Daejeon (KR)

(21) Appl. No.: 18/903,778

(22) Filed: Oct. 1, 2024

(30) Foreign Application Priority Data
Jan. 18, 2024 (KR) 10-2024-0007992

(51) Int. Cl. H04L 9/00; H04L 9/30; H04L 9/32

(52) U.S. Cl. CPC H04L 9/008; H04L 9/3026; H04L 9/3242

(57) ABSTRACT

Disclosed herein are a method and apparatus for generating searchable encrypted data. The method for generating searchable encrypted data may include converting data into a preset data format, generating a key by hashing a keyword of the data, generating a polynomial corresponding to the data based on an identifier (ID) of the data, and encrypting an coefficient of the polynomial using homomorphic encryption.

### CROSS REFERENCE TO RELATED APPLICATION

This application claims the benefit of Korean Patent Application No. 10-2024-0007992, filed Jan. 18, 2024, which is hereby incorporated by reference in its entirety into this application.

### BACKGROUND OF THE INVENTION

### 1. Technical Field

The present disclosure relates to a method for generating searchable encrypted data and searching the generated encrypted data.

More particularly, the present disclosure relates to encrypted data generation technology that is capable of processing a combined query even in an encrypted state based on the characteristics of homomorphic encryption.

### 2. Description of the Related Art

As the scale of the data industry increases, the range of data desired to be utilized is also expanding. However, the use of data that includes sensitive information, such as personal information, is limited due to the risk of information leakage.

In order to solve this problem, encryption systems that can increase the utilization of data while maintaining data security have been proposed. Representative encryption systems may include order-preserving encryption, order-revealing encryption, format-preserving encryption, etc.

Because conventional order-preserving encryption systems or order-revealing encryption systems are suitable only for size comparisons for a single data attribute, those systems are limited in processing combined queries. When a combined query request is received, additional tasks of processing individual queries and then selecting the relevant records are required. Accordingly, when a server is delegated to process these queries on behalf of the corresponding system, the risk of information exposure increases as the number of queries increases.

In order to solve the above problems, there is presented a method for generating and searching searchable encrypted data, which can process combined queries even in the state in which data is encrypted using the characteristics of homomorphic encryption.

### PRIOR ART DOCUMENTS

### Patent Documents

(Patent Document 1) Korean Patent Application Publication No. 2009-0053037 (Tile: Searching Method for Encrypted Data Using Inner Product and Terminal and Server Thereof)

### SUMMARY OF THE INVENTION

Accordingly, the present disclosure has been made keeping in mind the above problems occurring in the prior art, and an object of the present disclosure is to provide a combined search function in the state in which data is encrypted so as to securely utilize data containing sensitive information.

In accordance with an aspect of the present disclosure to accomplish the above object, there is provided a method for generating searchable encrypted data, including converting data into a preset data format; generating a key by hashing a keyword of the data; generating a polynomial corresponding to the data based on an identifier (ID) of the data; and encrypting an coefficient of the polynomial using homomorphic encryption.

Here, the data format may correspond to a format of {keyword|data ID}.

Here, a highest degree of the polynomial may be preset.

Here, encrypting the coefficient may include encrypting the coefficient of the polynomial for each degree.

Here, the method may further include transmitting the encrypted coefficient and the key to a database.

In accordance with another aspect of the present disclosure to accomplish the above object, there is provided a method for searching searchable encrypted data, including receiving a keyword for data search; generating a hash value by hashing the keyword; retrieving an encrypted coefficient of the data using the hash value; and generating a polynomial based on the encrypted coefficient.

Here, the method may further include decrypting the polynomial; and calculating a root of the decrypted polynomial.

Here, the root of the polynomial may be an integer root.

Here, the method may further include performing an requested operation using the encrypted coefficient.

In accordance with a further aspect of the present disclosure to accomplish the above object, there is provided an apparatus for generating searchable encrypted data, including a conversion unit configured to convert data into a preset data format; a key generation unit configured to generate a key by hashing a keyword of the data; and an encryption unit configured to generate a polynomial corresponding to the data based on an ID of the data and encrypt a coefficient of the polynomial using homomorphic encryption.

Here, the data format may correspond to a format of {keyword|data ID}.

Here, a highest degree of the polynomial may be preset.

Here, the encryption unit may encrypt the coefficient of the polynomial for each degree.

Here, the apparatus may further include a communication unit configured to transmit the encrypted coefficient and the key to a database.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a flowchart illustrating a method for generating searchable encrypted data according to an embodiment of the present disclosure;

FIG. 2 is a flowchart illustrating a method for searching searchable encrypted data according to an embodiment of the present disclosure;

FIG. 3 conceptually illustrates a data generation and search process in an encrypted data generation environment according to an embodiment of the present disclosure;

FIG. 4 is a flowchart illustrating a process of generating searchable encrypted data;

FIG. 5 is a flowchart illustrating a process of searching encrypted data;

FIG. 6 is a block diagram illustrating an apparatus for generating searchable encrypted data according to an embodiment of the present disclosure; and

FIG. 7 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

Hereinafter, embodiments of the present disclosure will be described in detail with reference to the accompanying drawings. In the following description of the present disclosure, the same reference numerals are used to designate the same or similar elements throughout the drawings and repeated descriptions of the same components will be omitted.

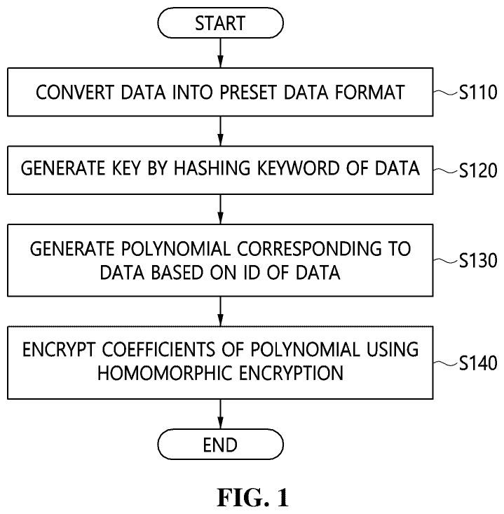

FIG. 1 is a flowchart illustrating a method for generating searchable encrypted data (or searchable encryption data) according to an embodiment of the present disclosure.

The searchable encrypted data generation method according to the embodiment of the present disclosure may be performed by an apparatus for generating searchable encrypted data, such as a computing device.

Referring to FIG. 1, the searchable encrypted data generation method according to the embodiment of the present disclosure may include step S110 of converting data into a preset data format, step S120 of generating a key by hashing the keyword of the data, step S130 of generating a polynomial corresponding to the data based on the identifier (ID) of the data, and step S140 of encrypting the coefficients of the polynomial using homomorphic encryption.

Here, the data format may correspond to the format of {keyword|data ID}. Here, the highest degree of the polynomial may be preset.

Here, the encryption step S140 may be performed to encrypt the coefficients of the polynomial for respective degrees.

Here, the method may further include the step of transmitting the encrypted coefficients and the generated key to a database (DB).

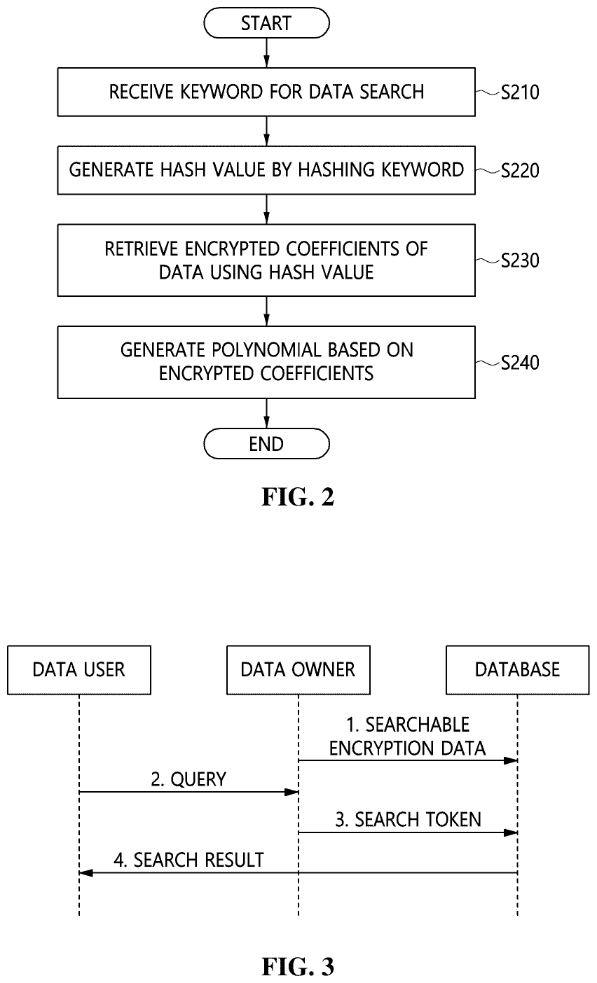

FIG. 2 is a flowchart illustrating a method for searching searchable encrypted data according to an embodiment of the present disclosure.

The searchable encrypted data search method according to the embodiment of the present disclosure may be performed by an apparatus for searching searchable encrypted data, such as a computing device.

Referring to FIG. 2, the searchable encrypted data search method according to the embodiment of the present disclosure may include step S210 of receiving a keyword for data search, step S220 of generating a hash value by hashing the keyword, step S230 of retrieving encrypted coefficients of the data using the hash value, and step S240 of generating a polynomial based on the encrypted coefficients.

Here, the method may further include the step of decrypting the polynomial and the step of calculating the roots of the decrypted polynomial.

Here, the roots of the polynomial may correspond to integer roots.

Here, the method may include performing a requested operation using the encrypted coefficients.

Hereinafter, embodiments of the present disclosure will be described in detail with reference to FIGS. 3 to 5.

FIG. 3 conceptually illustrates a data generation and search process in an encrypted data generation environment according to an embodiment of the present disclosure.

Referring to FIG. 3, the encrypted data generation environment according to the embodiment of the present disclosure may be composed of a data user, a data owner, and a database (DB). The data owner may establish a hashed result as a basic key by hashing the keyword of his or her own data, and may generate a polynomial from the IDs of documents including the keyword. For example, when the IDs of documents including the keyword ‘w’ are 1 and 3, the following polynomial is generated.

$$w ( x ) = ( x - 1 ) ( x - 3 ) = {x}^{2} - 4 x + 3$$

The coefficients of the generated polynomial may be encrypted using homomorphic encryption. Pieces of data such as those in the following Table 1 are finally generated based on the generated polynomial.

TABLE 1

| | Keyword | |
|---|---|---|
| Hash | Polynomial | Index |
| H(Apple) | Pw₁(x) = x² − | I₁ = {FHE(0), FHE(1), FHE(−4), FHE(3)} |
| | 4x + 3 | |
| H(Banana) | Pw₂(x) = x² − | I₂ = {FHE(0), FHE(1), FHE(−5), FHE(3)} |
| | 5x + 6 | |
| H(Cherry) | Pw₃(x) = x³ − | I₃ = {FHE(1), FHE(−8), FHE(19), |
| | 8x² + 19x − 12 | FHE(−12)} |
| H(Melon) | Pw₄(x) = x − 3 | I₄ = {FHE(0), FHE(0), FHE(1), FHE(−3)} |

When it is desired to search for the IDs of documents including keywords “Apple” and “Banana”, polynomials may be obtained by retrieving H (Apple) and H (Banana) values. Thereafter, a new polynomial of Pw_{R}=2x²−9x+9 may be generated by adding the retrieved polynomials Pw₁ and Pw₂. The corresponding polynomial is in an encrypted state. Accordingly, when the data user or data owner receives and decrypts the polynomial and obtains the integer root of the corresponding polynomial, an integer root of 3 becomes the search result. In order to match the degrees of the polynomial, the highest-degree term may be predefined, and 0 may be set when the corresponding degree is not present.

The data user may transfer the searchable encrypted data (or searchable encryption data) that is generated through the above-described method to the database. Thereafter, when the data owner receives a query from the data user, the data owner converts the query and transfers the converted query to the database, and the database may calculate the encrypted data without decrypting the encrypted data, and may transfer the search result to the data user.

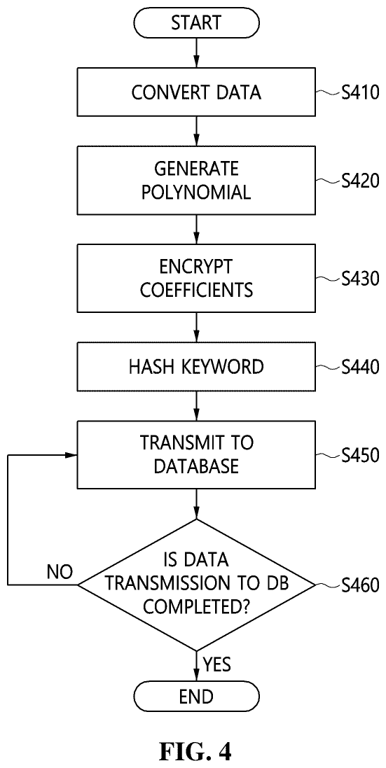

FIG. 4 is a flowchart illustrating a process of generating searchable encrypted data.

Referring to FIG. 4, a data owner converts data, having the format of {document ID|keyword}, into the format of {keyword|document ID} at step S410. Based on the converted data, a polynomial may be generated in the above-described format at step S420. Next, the coefficients of the generated polynomial are encrypted for respective degrees using homomorphic encryption at step S430. Further, a data key is generated by hashing a keyword at step S440. The encrypted coefficients may be transmitted, together with the hash value of the keyword corresponding to the polynomial, to the database at steps S450 and S460.

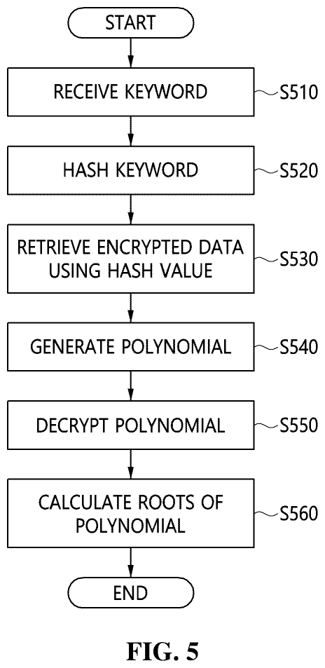

FIG. 5 is a flowchart illustrating a process of searching encrypted data.

Referring to FIG. 5, a data owner who receives a search keyword from a data user converts the keyword through a hash function to transfer a query to the database at steps S510 and S520. The database retrieves encrypted coefficient values using the received hashed keyword value at step S530, and transfers a retrieved result to the data user. When the database receives an AND operation having two or more retrieved keywords, all of retrieved coefficients are added for respective degrees to generate a polynomial, and the generated polynomial is transferred to the data user at step S540. The data user obtains a result value by decrypting the polynomial and calculating the roots of the polynomial at steps S550 and S560. The encrypted polynomial from the database may also be received and decrypted by the data owner to obtain roots depending on a situation in which the system is constructed, after which the roots may be delivered to the data user.

By means of the method according to the embodiment of the present disclosure, data search may be performed in a data-encrypted state, and a combined query such as an AND operation may be performed. Also, because an operation is performed in the database without decrypting the encrypted data, a database manager cannot know the content of the encrypted data, and thus data security and utilization may be improved.

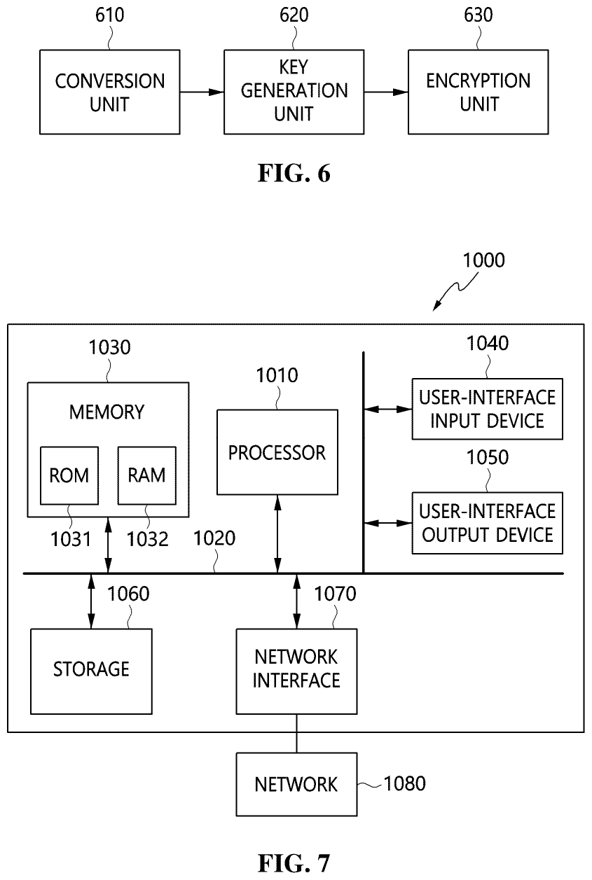

FIG. 6 is a block diagram illustrating an apparatus for generating searchable encrypted data according to an embodiment of the present disclosure.

Referring to FIG. 6, the apparatus for generating searchable encrypted data according to the embodiment of the present disclosure may include a conversion unit 610 for converting data into a preset data format, a key generation unit 620 for generating a key by hashing the keyword of the data, and an encryption unit 630 for generating a polynomial corresponding to the data based on the ID of the data and encrypting the coefficients of the polynomial using homomorphic encryption.

Here, the data format may correspond to the format of {keyword|data ID}.

Here, the highest degree of the polynomial may be preset.

Here, the encryption unit 630 may encrypt the coefficients of the polynomial for respective degrees.

Here, the apparatus may further include a communication unit for transmitting the encrypted coefficients and the key to the database.

FIG. 7 is a diagram illustrating the configuration of a computer system according to an embodiment.

An apparatus for generating searchable encrypted data may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

Specific executions described in the present disclosure are embodiments, and the scope of the present disclosure is not limited to specific methods. For simplicity of the specification, descriptions of conventional electronic components, control systems, software, and other functional aspects of the systems may be omitted. As examples of connections of lines or connecting elements between the components illustrated in the drawings, functional connections and/or circuit connections are exemplified, and in actual devices, those connections may be replaced with other connections, or may be represented by additional functional connections, physical connections or circuit connections. Furthermore, unless definitely defined using the term “essential”, “significantly” or the like, the corresponding component may not be an essential component required in order to apply the present disclosure.

According to the present disclosure, combined search may be performed in the state in which data is encrypted so as to securely utilize data containing sensitive information.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. A method for generating searchable encrypted data, comprising:
converting data into a preset data format;
generating a key by hashing a keyword of the data;
generating a polynomial corresponding to the data based on an identifier (ID) of the data; and
encrypting an coefficient of the polynomial using homomorphic encryption.

2. The method of claim 1, wherein the data format corresponds to a format of {keyword|data ID}.

3. The method of claim 1, wherein a highest degree of the polynomial is preset.

4. The method of claim 1, wherein encrypting the coefficient comprises:
encrypting the coefficient of the polynomial for each degree.

5. The method of claim 4, further comprising:
transmitting the encrypted coefficient and the key to a database.

6. A method for searching searchable encrypted data, comprising:
receiving a keyword for data search;
generating a hash value by hashing the keyword;
retrieving an encrypted coefficient of the data using the hash value; and
generating a polynomial based on the encrypted coefficient.

7. The method of claim 6, further comprising:
decrypting the polynomial; and
calculating a root of the decrypted polynomial.

8. The method of claim 7, wherein the root of the polynomial is an integer root.

9. The method of claim 6, further comprising:
performing an requested operation using the encrypted coefficient.

10. An apparatus for generating searchable encrypted data, comprising:
a conversion unit configured to convert data into a preset data format;
a key generation unit configured to generate a key by hashing a keyword of the data; and
an encryption unit configured to generate a polynomial corresponding to the data based on an ID of the data and encrypt a coefficient of the polynomial using homomorphic encryption.

11. The apparatus of claim 10, wherein the data format corresponds to a format of {keyword|data ID}.

12. The apparatus of claim 10, wherein a highest degree of the polynomial is preset.

13. The apparatus of claim 10, wherein the encryption unit encrypts the coefficient of the polynomial for each degree.

14. The apparatus of claim 13, further comprising:
a communication unit configured to transmit the encrypted coefficient and the key to a database.
